(19) United States
(12) Patent Application Publication
(10) Pub. No.: US 2008/0127476 A1
(43) Pub. Date: Jun. 5, 2008

(54) Method of mitigating the effects of damage in an article

(75) Inventor: Paul S. Prevey, Cincinnati, OH (US)

Correspondence Address: Mark F. Smith, 905 Ohio Pike, Cincinnati, OH, 45245, US

(73) Assignee: Surface Technology Holdings, Ltd.

(21) Appl. No.: 11/977,035

(22) Filed: Oct. 23, 2007

Related U.S. Application Data
(60) Provisional application No. 60/854,040, filed on Oct. 24, 2006.

(51) Int. Cl. B23P 6/00

(52) U.S. Cl. 29/402.04; 29/402.19

(57) ABSTRACT

A method of mitigating the effects of damage to a metallic, ceramic, or intermetallic article through the introduction of compressive residual stresses taking into account the effects of the stress concentration factor associated with a damage notch under compression. A layer of compressive residual stress is introduced into the surface of the article to a depth greater than the depth to which damage, such as corrosion pitting or foreign object damage, extends into the surface of the part. The induced compressive residual stresses improve the fatigue and stress corrosion cracking performance of the article while the stress concentrating properties associated with a damage notch under compression prevents cracks from initiating from within the notch under applied loads.

This application claims the benefit of U.S. Provisional Application No. 60/854,040, filed Oct. 24, 2006.

### BACKGROUND OF THE INVENTION

The present invention relates to a method of treating an article and, more particularly, to a method of inducing compressive residual stress in areas of an article subject to localized surface damage, such as foreign object damage, fretting, or corrosion, to mitigate failures caused by these mechanisms.

Articles made from metallic, ceramic and intermetallic materials may be subject to localized surface damage, including foreign object damage (FOD), fretting, and corrosion pitting, each of which adversely impacts the fatigue strength of the article. Each of these damage mechanisms produces indentations, pits, cracks, or similar notch-like features that serve as stress concentrators or stress risers such that, as the article experiences an applied stress, the material at the tip of the notch-like feature experiences greater stress than undamaged areas of the same article. It is well known that the degree to which the damage multiplies or magnifies the applied stress is a function of the depth and shape of the notch-like feature. For instance, damage resulting in a sharp V-shaped feature has a greater associated stress intensifying effect than damage resulting in a rounded feature of the same depth. Using well known closed form solutions or finite element analysis, modern stress analysis has quantified the degree to which stress is increased by a notch-like feature as the mechanical stress concentration factor, or kₜ, which, when multiplied by the applied stress, yields the stress experienced by the material at the bottom of the notch-like feature. The effect of the stress concentration on fatigue life can be described by the fatigue notch factor or fatigue stress concentration factor, k_{f}, defined as the higher smooth surface fatigue strength divided by the fatigue strength in the notched condition. The fatigue notch factor is less than or equal to the mechanical stress concentration factor: 1≦k_{f}≦kₜ, and is generally determined empirically.

If the article is subject to cyclic loading, such as the blading members of turbine engines, gear teeth, rotating shafts, and the like, the concentration of stress in the damaged area may serve as an initiation point for fatigue cracks that may ultimately lead to the failure of the article due to fatigue. Fatigue cracks initiate and propagate to failure when the stress at the notch tip, amplified by the stress concentration factor of the notch feature, approaches or exceeds the endurance limit of the article. The article is then highly susceptible to the development of fatigue cracks, especially in the damaged area. Thus, the coincidence of FOD, corrosion pitting, and other forms of damage with cyclic loading significantly reduces the fatigue life of articles, influencing both safety and maintenance costs. In particular, aerospace components such as the blading members of gas turbine engines, aircraft structures, and landing gear are highly susceptible to FOD that may ultimately lead to fatigue failure. Given the potentially catastrophic results of such failures, it is common practice to frequently and regularly inspect fatigue-life limited articles used in aerospace applications for various forms of damage. Any damage or cracking found during inspection is assessed, and the article is retired from service due to the extent of the damage or else repaired and returned to service.

A currently accepted practice for mitigating the effects of damage due to FOD, corrosion pitting, and the like, is to remove the damaged portion of the article and adjacent material by abrasive grinding, filing, machining, and/or polishing so as to “blend” the damaged area into adjacent, undamaged areas thereby altering the notch feature into a wide shallow depression with a width to depth ratio generally on the order of 6:1. This “blending” process mitigates the nucleation of fatigue cracks in the damaged area by altering the geometry of the damage, reducing the associated stress concentration factor and, thus, the stress acting on the area and the resulting reduction in fatigue strength.

While effective for mitigating the impact of damage, the blending process has several drawbacks. The blending process is labor intensive and, therefore, greatly increases repair and maintenance costs. Also, during blending, material is removed from the article thereby decreasing the overall strength of the article. Also, abrasively grinding the article may introduce undesirable residual tensile stresses thereby necessitating an additional treatment, such as shot peening, to mitigate the adverse impact of such stresses. Further, in the case of FOD occurring along the edges or tips of an article such as a blade or vane used in a gas turbine engine, removal of material decreases the aerodynamic performance of the article.

With respect to articles used in the aerospace industry, the inspection, repair, and retirement of articles from service adversely impacts both the flight readiness and maintenance costs of equipment. By way of example, it is estimated that the United States military currently spends $2 billion annually on the inspection, maintenance and repair of aircraft engines and related components in the U.S. arsenal.

Accordingly, a need exists for a low cost, easily implemented method for mitigating localized surface damage in metallic, ceramic and intermetallic articles to increase fatigue life, decrease maintenance and inspection costs, and improve equipment readiness.

### SUMMARY OF THE INVENTION

The present invention is directed to a method, which fulfills the need for a low cost, easily implemented method to mitigate damage to metallic, ceramic and intermetallic articles to increase fatigue life, decrease maintenance and inspection costs, and improve equipment readiness. The method comprises introducing compressive residual stresses in damaged or potentially damaged areas of the article to mitigate the effects of damage and the risk of fatigue failure. The induced compressive stress extends beneath the surface of the article to a depth greater than the penetration depth of the damage mechanism such that the tips of the notch-like features caused by the damage are in compression. The method utilizes the stress concentration factor associated with the tip of a damage-induced notch-like feature combined with sufficient induced residual compressive stress at the depth of the notch tip to exceed the applied tension in service such that the crack tip remains in higher compression than the surrounding material. If the local residual compression at the fatigue critical location where notch-like damage may occur or at an existing notch tip is greater than the applied tension, then the notch tip will always be in compression with a magnitude equal to the stress concentration factor of the notch times the net compression. Using this method, the notch-like feature always remains in compression, and fatigue cracks can neither initiate nor grow to failure. As a result, the induced compressive stress need only exceed the applied tensile stresses and not necessarily the applied tensile stresses multiplied by the stress intensity factor.

In one embodiment, the damage incident on the article is assessed and a stress intensity factor based on the damage geometry or the fatigue notch stress factor is determined. The distribution of applied stresses acting on the article during operation is then determined. A residual compressive stress distribution is designed and introduced into the article in the area surrounding the damage and to a depth greater than the damage to prevent the nucleation and growth of fatigue cracks from the damaged area.

In another embodiment, the induced compressive residual stress distribution includes at least the portion of the damaged area that may be most prone to cracking.

In another embodiment, the induced compressive residual stress distribution includes the entire damaged area.

In another embodiment, the induced compressive residual stress distribution extends into the surface of the article to a depth known from operational experience to be greater than the depth to which damage penetrates the surface of the article.

In another embodiment, the induced compressive residual stress distribution extends through the thickness of the article.

In another embodiment, the magnitude of the induced compressive residual stress distribution at the tip of the damage notch-like feature partially offsets the applied stress acting on the notch-like feature such that the sum of stresses acting on the notch-like feature multiplied by the stress concentration factor of the notch-like feature is less than the endurance limit for the material such that fatigue cracks do not initiate or grow.

In another embodiment, the magnitude of the induced compressive residual stress distribution at the tip of the damage notch-like feature completely offsets the applied tensile stresses acting on the notch-like feature such that the tip of the feature remains in compression during operational loading.

In another embodiment, the magnitude of the induced compressive residual stress distribution is minimized thereby reducing the associated equilibrating tension and minimizing distortion of the article.

In another embodiment the invention is a metallic, intermetallic, or ceramic article treated according to the method disclosed herein.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing damage along the edge of an article such as a blading member of a turbine engine, and graphically demonstrates the stress concentration effects at the tip of a notch-like feature.

FIG. 2 is a graphical representation of stress versus position along a notch-like damage feature under applied tensile load. The stress is at a maximum at the tip of the notch-like feature due to the stress concentration factor kₜ.

FIG. 3 is an exploded view showing the compressive stresses acting on the tip of the notch-like feature after application of the method of the present invention. The combination of compressive stresses with the stress intensity factor greatly increases the “squeezing” effect at the tip of the notch-like feature thereby preventing or arresting crack development and propagation.

FIG. 4 is a graphical representation of stress versus position along a notch-like damage feature where the applied tensile stress is completely offset by an induced compressive residual stress. The maximum compression occurs at the tip of the notch-like feature due to the stress concentration factor kₜ. Because the tip of the notch-like feature remains in compression even under applied load, the risk of fatigue cracks nucleating from the tip of the notch-like feature is completely mitigated.

FIG. 5 is a graphical representation of stress versus position along a notch-like damage feature where the applied tensile stress is partially offset by an induced compressive residual stress. The stress at the tip of the notch-like feature is less than the endurance limit of the material so fatigue cracking is mitigated.

### DETAILED DESCRIPTION OF THE INVENTION

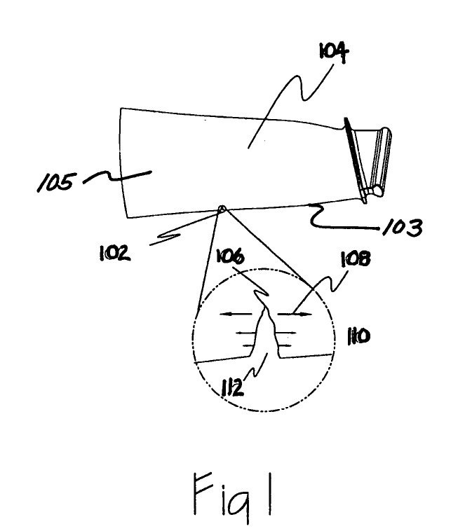

Damage mechanisms, such as foreign object damage (FOD), corrosion pitting, and fretting, have an adverse impact on the fatigue life of articles subject to alternating stress. FIG. 1 shows an article 104, in this case a blading member for use in a gas turbine engine, with damage 102, specifically foreign object damage (FOD), along the edge 103 of the article 104. The exploded view 110 of the notch-like feature 112 caused by the FOD 102 shows the geometry of the damage 102 in this illustrative example to be a V-shaped notch-like feature 112 extending into the body 105 of the article 104. The forward most portion of the notch-like feature 112 terminates in a sharp notch tip 106.

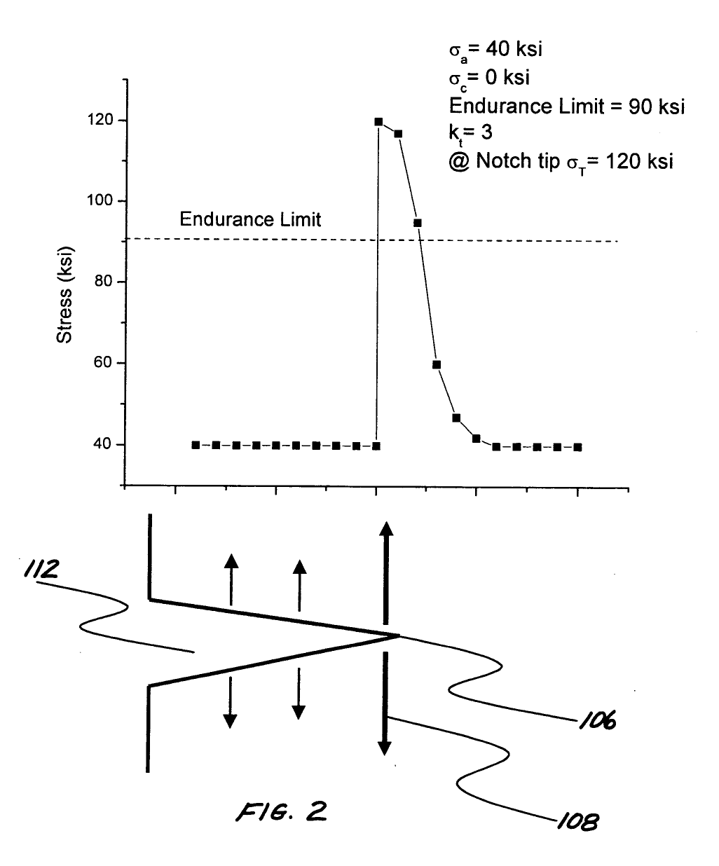

When stress 108 is applied to the article 104, the FOD 102 acts as a stress riser or stress concentration, and multiplies the stress experienced by the article 104 directly adjacent to the notch tip 106. The degree to which the stress is increased is governed by the stress concentration factor, kₜ. The stress concentration factor is based on the geometry of the notch-like feature 112 or indentation produced by the damage 102. A typical stress concentration factor for a V-shaped notch-like feature 112 such as that shown in FIG. 1 would be kₜ≈3. Therefore, under applied load, the stress 108 experienced at the notch tip 106 is on the order of 3 times greater than in an un-notched article. This effect is illustrated in FIG. 2. If the net stress at the notch tip multiplied by the stress concentration factor equals or exceeds the endurance limit for the material (defined as the cyclic stress level below which failure by fatigue never occurs), the article will be susceptible to fatigue cracks nucleating from the damaged area. If the net stress multiplied by kₜ exceeds the fatigue strength required for a given design life, fatigue cracking or failure will occur before the design life of the article is reached. Without mitigation, the article will ultimately fail due to fatigue. Example 1 below is a hypothetical example of a failure due to unmitigated damage.

### EXAMPLE 1

### No Mitigation of Applied Stresses

Referring to FIG. 1, an article 104, such as a titanium alloy compressor blade, has a V-shaped FOD notch-like feature 112. The notch-like feature 112 has a stress intensity factor of kₜ=3. The endurance limit for the article is 90 ksi. The location of the notch-like feature 112, prior to damage, is subject to an applied stress of 40 ksi. After damage, the area 102 at the base of the FOD notch-like feature 112 is subject to a total stress (σ_{T}) equal to the applied stress (σₐ) multiplied by the stress intensity factor (kₜ). Therefore, after damage, the total stress (σ_{T}) 108 acting on the notch tip 106 is 120 ksi. Because the stress 108 acting on the notch tip 106 exceeds the endurance limit for the material (90 ksi), the article 104 would have a significantly reduced fatigue life and ultimately fail as a result of fatigue cracks nucleating out of the notch-like feature 112. The magnitude of stresses acting along the notch-like feature 112 is graphically illustrated in FIG. 2.

The method of mitigating the effects of damage 102 in an article 104 involves introducing a compressive residual stress distribution in the volume of material subject to or containing the damage 102. The compressive residual stress distribution offsets the applied stresses acting on the article 104 in the area of the damage 102 thus preventing the total, or net, stress acting on the damaged area from reaching or exceeding the endurance limit or fatigue strength of the material. With the total stress incident at the notch tip 106 maintained at a value below the endurance limit or fatigue strength, the article 104 will not fail from fatigue cracks nucleating from the damage 102.

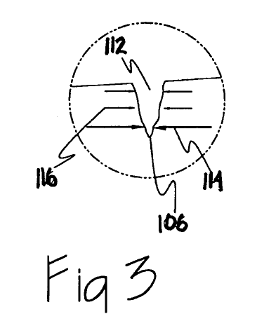

FIG. 3 shows the effects of a compressive residual stress distribution 116 introduced in the material surrounding the notch-like feature 112. The compressive residual stresses counteract the applied tensile stresses and essentially “squeeze” the notch-like feature 112 closed, thus preventing the nucleation of fatigue cracks from the notch tip 106. Further, the stress concentration factor, kₜ, also acts in compression as well as in tension. Therefore, if a compressive residual stress distribution 116 of sufficient magnitude is introduced in the damaged area 102 so as to leave the material at the depth of the notch-like feature 112 formed by the damage 102 in a state of compression under applied tensile load, the actual magnitude of compression experienced at the notch tip 106 will be a product of the net residual compressive stress multiplied by the stress intensity factor kₜ. Utilizing this relationship, it has been found that the risk of fatigue failure can be completely mitigated by introducing a residual compressive stress distribution of greater magnitude than the applied stress without the necessity of blending the notch-like features 112 to reduce the stress concentration factor. The stress concentration factor associated with the notch-like feature 112 increases the benefits of the induced compression provided the notch tip 106 remains in net compression under applied load. The need for blending is eliminated and the extensive inspection currently practiced to ensure safe operation of damage prone fatigue limited components can be reduced.

The method of mitigating the effects of damage on an article comprises the steps of characterizing the damage incident on the article. This includes determining the nature or cause of the damage, and determining the depth or extent to which the damage penetrates the surface or body of the article. The geometrical configuration of the damage is also assessed, and based on this geometry, a stress concentration factor, kₜ, is determined for the incident damage. Alternately, the value of k_{f} may be determined from the actual failure history of the article in service, or from laboratory fatigue testing.

The distribution and magnitude of applied stresses acting on the article are also determined. These determinations may be based on the original design of the article, operational experience, direct measurement techniques, computer modeling, finite element analysis and/or combinations thereof.

A compressive residual stress distribution is then designed for the article. The magnitude and location of stress in the compressive residual stress distribution is specifically designed to offset the applied stresses acting on the article in the damaged area. In a preferred embodiment, the compressive residual stress distribution includes at least the entire damaged or damage prone area of the article. In another embodiment, the compressive residual stress distribution in the damaged prone area includes the portion of the damaged volume surrounding the notch tip. The compressive residual stress distribution extends beneath the surface of the article to a depth greater than the depth of damage and, where necessary, through the entire thickness of the article.

The magnitude of stress in the compressive residual stress distribution is selected to offset the applied stresses acting on the article. In one embodiment, the magnitude of compressive residual stresses is optimized to completely offset the applied stresses such that the net stress acting on the area subject to surface damage is entirely compressive during operational loading. Because the stress concentration factor, kₜ, operates in compression as well as in tension, and the area surrounding the area subject to surface damage is under compression, the actual value of the compressive stress acting on the notch tip is the product of the compressive stress multiplied by the stress concentration factor. Utilizing this relationship instead of blending to remove the notch-like feature and reduce kₜ, the risk of fatigue failure from fatigue cracks nucleating from the damaged area is mitigated and the need for blending to remove the damage is avoided. The presence of the damage induced notch combined with the optimized induced compressive residual stress distribution not only offsets the applied tensile stress, but actually leaves the notch tip in compression of greater magnitude than the induced residual compressive stress distribution. Example 2 below is a hypothetical example in which applied stresses are completely mitigated through the introduction of a compressive residual stress distribution.

After designing a suitable compressive residual stress distribution, the compressive residual stress distribution is introduced into the article by any process for inducing a controlled compressive residual stress including burnishing, deep rolling, low plasticity burnishing, laser shock peening, shot peening, glass bead peening, pinch peening, quenching, coining, indenting, and/or combinations thereof.

### EXAMPLE 2

### Complete Mitigation of Applied Stresses

The notch-like feature 112 discussed in Example 1 is now treated according to the method of the present invention and a residual compressive stress distribution 116 is introduced around the notch tip 106. The magnitude of the compressive residual stress distribution 116 is −50 ksi. The total stress 114, σ_{T}, acting on the notch tip 106 during service is:

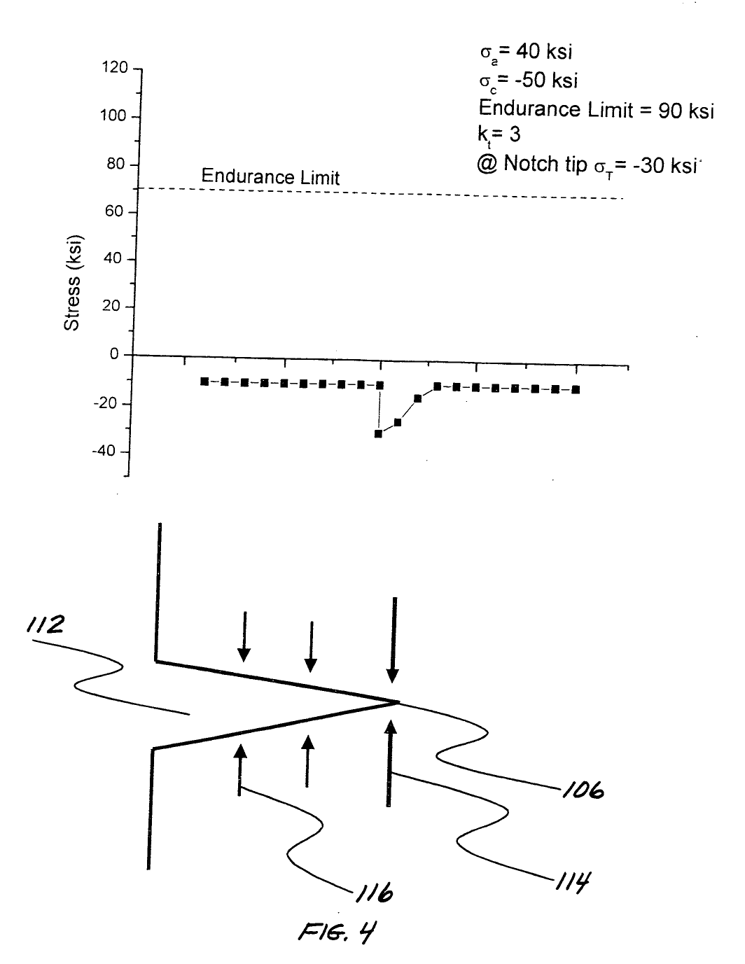

σ_{T}=(σ_{z}+σ_{c})×kₜ

where σₐ is the maximum applied stress (40 ksi), σ_{c} is the magnitude of the residual compressive stress distribution 116 at the notch tip 106 (−50 ksi), and kₜ=3 is the stress intensity factor for the notch configuration. Therefore, after treatment to induce the residual compressive stress, the total stress 114 acting on the notch tip 106 during service of the metallic article is −30 ksi. Thus the notch-like feature 112 remains in compression even under the maximum tensile applied loading conditions. Because the stress 114 acting on the notch tip 106 is less than the endurance limit and always compressive, it is impossible for fatigue cracks to nucleate and grow, and the risk of fatigue failure is completely mitigated. Example 2 is graphically illustrated in FIG. 4.

The results of Example 2 indicate that the volume of material immediately adjacent the notch tip 106 has a net compressive stress of −30 ksi due to the effects of the stress concentration factor. In comparison, other undamaged or un-notched material in the article 104 subject to the induced compressive stress of −50 ksi and the applied stress of 40 ksi has a net compressive stress of −10 ksi. Because the material at and adjacent to the notch tip 106 is more compressive than material in the undamaged areas, the material adjacent to the notch tip 106 has a greater ability to resist the development of fatigue cracks.

Utilizing the relationship between the induced compressive residual stress distribution and the stress intensity factor, kₜ, it is now possible to optimize the compressive residual stress induced in a part so as to achieve maximum possible benefit with a minimum magnitude of compression. In turn, this reduces the magnitude of equilibrating tensile stresses that accompany the introduction of compressive stresses thereby reducing both the possibility of failure from the regions in equilibrating tension and the amount of distortion that develops in the part.

Based on material and geometric limitations, it may not be possible to introduce a compressive residual stress of sufficient magnitude to completely offset the applied stresses acting on the article during operation. Under such conditions it is possible to partially mitigate the effects of damage by designing a compressive residual stress distribution that partially offsets the applied stresses such that, during operational loading, the stress experienced by the article, including the effects of the stress concentration factor, are less than the endurance limit for the material or less than the fatigue strength required to achieve the desired design life. Example 3 below is a hypothetical example in which applied stresses are partially mitigated through the introduction of a compressive residual stress distribution.

### EXAMPLE 3

### Partial Mitigation of Applied Stresses

The notch-like feature 112 discussed in Example 1 is now treated according to the method of the present invention and a residual compressive distribution is introduced around the notch tip 106. The induced compressive residual stress is −30 ksi. The total stress 108, σ_{T}, acting on the notch tip 106 during service is:

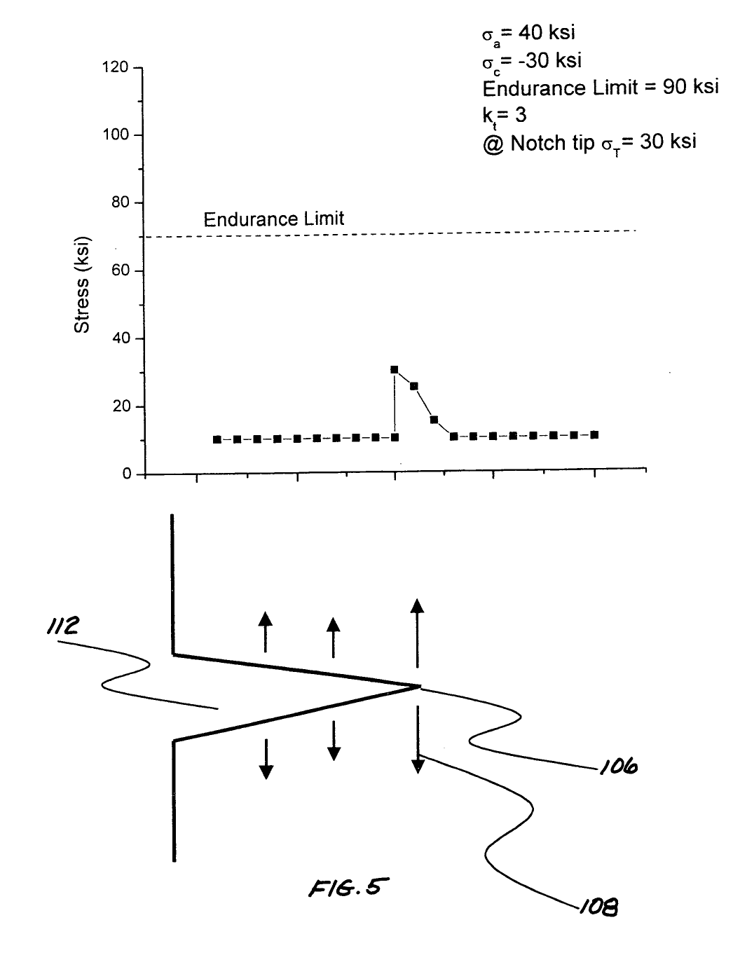

σ_{T}(σₐ+σ_{c})×kₜ

where σₐ is the maximum applied stress (40 ksi), σ_{c} is the magnitude of the residual compressive stress distribution (−30 ksi), and kₜ=3 is the stress intensity factor for the notch-like feature 112 configuration. Therefore, the total stress 108 acting on the notch tip 106 after treatment is tensile, +30 ksi. As this value is much less than the endurance limit of the material (90 ksi) the risk of fatigue cracks nucleating from the notch-like feature 112 is effectively mitigated. Example 3 is graphically illustrated in FIG. 5.

The surface treatment method of the present invention can be used to treat a variety of metallic, ceramic and intermetallic articles subject to foreign object damage, corrosion, fretting and/or stress corrosion cracking. This includes, but is not limited to, aircraft, naval, steam, and ground-based turbines and associated components, aircraft structural components, aircraft landing gear and components, metallic weldments, piping and components used in nuclear, fossil fuel, steam, chemical, and gas plants, distribution piping for gases and fluids, automotive components such as gears, springs, shafts, connecting rods, and bearings, ship hulls, propellers, impellers, and shafts, rail transport components and tracks, and various other components and structures too numerous to be mentioned herein.

A principle advantage of the present invention is the ability to optimize the compressive residual stress distribution induced in the article by utilizing the stress intensity factor as applied to compressive stresses. In this manner a minimal amount of compressive stress can be induced in the article so as to realize the maximum benefit while minimizing compensating tensile stresses and distortion associated with the process.

Another principal advantage of the present invention is the use of a designed level of induced compressive residual stress in the areas of an article prone to damage to eliminate the need to remove the notches or indentations caused by damage. In this manner the cost of blending to remove the notch-like features and indentations is eliminated. Because notches shallower than the depth of the compressive layer need not be removed, inspection for damage requires only the identification of deeper notch-like features, reducing both the time and expense of inspection while improving equipment availability.

Another principle advantage of the present invention is the ability to restore and even improve the fatigue life of a damaged article through the introduction of a designed compressive residual stress distribution. This facilitates the return of the article to service without risk of failure. Because the damaged article is repaired rather than replaced, operation and maintenance costs are reduced.

Another advantage of the present invention is the ability to repair damaged blading members for use in turbine engines without adversely impacting the aerodynamic properties of the blading member.

Although the present invention has been described in considerable detail with reference to certain preferred embodiments thereof, other embodiments are possible. Therefore, the scope of the appended claims should not be limited to the description of the preferred embodiments contained herein.

What is claimed is:

1. A method of mitigating the effects of surface damage in an article prone to damage comprising the acts of:
characterizing damage incident on the article;
determining the stress concentration or fatigue notch factor in the prone area for the incident damage;
determining the distribution and magnitude of applied stresses acting on the article;
designing a compressive residual stress distribution to offset the applied stresses acting on the article in the prone area;
introducing the compressive residual stress distribution in the prone area to offset the applied stresses acting on the article such that the compressive residual stress distribution forward of (or beneath) the damage has a greater magnitude of compression due to the effects of the stress concentration factor.

2. The method of claim 1 wherein the act of characterizing the damage comprises determining the cause of the damage and the extent to which the damage extends beneath the surface of the article.

3. The method of claim 1 wherein the act of determining the stress concentration for the incident damage includes determining the maximum stress concentration factor for the damage.

4. The method of claim 1 wherein the stress concentration factor for the incident damage is determined from the geometry of the damage, the failure history of the article, fatigue testing of the article, finite element modeling, and/or combinations thereof.

5. The method of claim 1 wherein the magnitude and distribution of stresses acting on the article is determined by assessing the design of the article, operational experience, direct measurement, computer modeling, finite element analysis and/or combinations thereof.

6. The method of claim 1 wherein the compressive residual stress distribution extends substantially through the thickness of the article.

7. The method of claim 1 wherein the compressive residual stress distribution extends to a depth greater than the depth of damage incident on the article.

8. The method of claim 1 wherein, after the compressive residual stress distribution has been introduced in the article, the net stress in the damaged area is less than the endurance limit or fatigue strength of the article.

9. The method of claim 8 wherein the net stress in the damaged area is compressive.

10. The method of claim 1 wherein, after the compressive residual stress distribution has been introduced in the article, the area surrounding the damage, including the area forward of (beneath) the damage, is in compression and remains in compression under applied stress.

11. The method of claim 1 wherein the damage comprises fatigue cracks, foreign object damage, fretting, corrosion damage, corrosion pitting, and/or stress corrosion cracking damage.

12. A repaired article comprising a damaged area and an area of compressive residual stress, wherein the area of compressive residual stress includes at least the entire damaged area.

13. The article of claim 12 wherein the area of compressive residual stress includes at least the forward most portion of the damaged area.

14. The article of claim 12 wherein an area of the article surrounding the damaged area, including the area forward of the damaged area, is in compression and remains in compression under applied stress.

15. The article of claim 12 wherein the area of compressive residual stress extends substantially through the thickness of the article.

16. The article of claim 12 wherein the area of compressive residual stress extends beneath the surface of the article to a depth greater than the damaged area.

17. An article with improved resistance to failure from localized surface damage comprising:
at least one area prone to localized surface damage;
at least one area of compressive residual stress that includes the at least one area prone to localized surface damage;
wherein the article is subject to an applied load and the net stress acting on the at least one area prone to localized surface damage multiplied by the stress concentration factor of the surface damage is less than the endurance limit and/or fatigue strength of the article.

18. The article of claim 17 wherein the net stress acting on the at least one area prone to localized surface damage is compressive.

19. The article of claim 17 wherein the area of compressive residual stress extends substantially through the thickness of the metallic article.

20. The article of claim 17 wherein the area of compressive residual stress extends beneath the surface of the article to a depth greater than the damage prone area.
